(19) United States
(12) Patent Application Publication
(10) Pub. No.: US 2024/0419808 A1
(43) Pub. Date: Dec. 19, 2024

(54) SYSTEMS, METHODS, AND MEDIA FOR VERIFYING SOFTWARE

(71) Applicant: The Trustees of Columbia University in the City of New York, New York, NY (US)

(72) Inventors: Jason Nieh, New York, NY (US); Wei Qiang, New York, NY (US); Xuheng Li, New York, NY (US); Xupeng Li, New York, NY (US); Ronghui Gu, New York, NY (US)

(21) Appl. No.: 18/745,839

(22) Filed: Jun. 17, 2024

Related U.S. Application Data
(60) Provisional application No. 63/521,667, filed on Jun. 17, 2023.

(51) Int. Cl. G06F 21/57

(52) U.S. Cl. CPC G06F 21/577; G06F 2221/033

(57) ABSTRACT

Mechanisms for verifying software are provided, the mechanisms including: identifying a plurality of layers of code of the software including a lowest layer, a middle layer, and a highest layer; generating a low-level specification and an identical refinement proof for each of the plurality of layers using a hardware processor; generating a high-level specification and a lifting refinement proof for each of the plurality of layers; and verifying the software based on the low-level specifications, the identical refinement proofs, the high-level specifications, and the lifting refinement proofs. In some embodiments, one of the low-level specifications is generated using Fixedpoint construction. In some embodiments, one of the high-level specifications is generated by applying a set of transformation rules to one of the low-level specifications.

### CROSS REFERENCE TO RELATED APPLICATION

This application claims the benefit of U.S. Provisional Patent Application No. 63/521,667, filed Jun. 17, 2023, which is hereby incorporated by reference herein in its entirety.

### STATEMENT REGARDING GOVERNMENT FUNDED RESEARCH

This invention was made with government support under 2052947, 1918400, and 2124080 awarded by the National Science Foundation and N66001-21-C-4018 awarded by DARPA. The government has certain rights in the invention.

### BACKGROUND

System software, such as operating systems and hypervisors, forms the software foundations of our computing infrastructure. However, modern system software is large, complex, and imperfect, with vulnerabilities that can be exploited to compromise the security of a system. Formal verification offers a potential solution to this problem by mathematically proving that system software can provide critical security guarantees. This typically involves verifying that the software implementation satisfies a formal high-level specification of its behavior, then proving that the specification guarantees the desired security properties.

The former, referred to as functional correctness, is generally the most challenging part to do, given the complexity of system software implementations. Implementations are commonly written in C, which has complex semantics and language features, many unsupported by verification tools.

Verification tools powerful enough to verify real-world system software are difficult and tedious to use when writing specifications and proofs. Furthermore, a high-level specification that is useful for verifying higher-level properties such as security often has a significant semantic gap from the implementation, requiring substantial manual proof effort to bridge this gap. However, without functional correctness to ensure that the proofs hold on the actual implementation, formally verified guarantees can be meaningless in practice.

Accordingly, new mechanisms for verifying software are desirable.

### SUMMARY

In accordance with some embodiments, mechanisms, including systems, methods, and media, for verifying software are provided.

In some embodiments, systems for verifying software are provided, the systems comprising: memory; and at least one hardware processor collectively configured to at least: identify a plurality of layers of code of the software including a lowest layer, a middle layer, and a highest layer; generate a low-level specification and an identical refinement proof for each of the plurality of layers; generate a high-level specification and a lifting refinement proof for each of the plurality of layers; and verify the software based on the low-level specifications, the identical refinement proofs, the high-level specifications, and the lifting refinement proofs. In some of these embodiments, one of the low-level specifications is generated using Fixedpoint construction. In some of these embodiments, one of the high-level specifications is generated by applying a set of transformation rules to one of the low-level specifications.

In some embodiments, methods for verifying software are provided, the methods comprising: identifying a plurality of layers of code of the software including a lowest layer, a middle layer, and a highest layer; generating a low-level specification and an identical refinement proof for each of the plurality of layers using a hardware processor; generating a high-level specification and a lifting refinement proof for each of the plurality of layers; and verifying the software based on the low-level specifications, the identical refinement proofs, the high-level specifications, and the lifting refinement proofs. In some of these embodiments, one of the low-level specifications is generated using Fixedpoint construction. In some of these embodiments, one of the high-level specifications is generated by applying a set of transformation rules to one of the low-level specifications.

In some embodiments, non-transitory computer-readable media containing computer executable instructions that, when executed by a processor, cause the processor to perform a method for verifying software are provided, the method comprising: identifying a plurality of layers of code of the software including a lowest layer, a middle layer, and a highest layer; generating a low-level specification and an identical refinement proof for each of the plurality of layers; generating a high-level specification and a lifting refinement proof for each of the plurality of layers; and verifying the software based on the low-level specifications, the identical refinement proofs, the high-level specifications, and the lifting refinement proofs. In some of these embodiments, one of the low-level specifications is generated using Fixedpoint construction. In some of these embodiments, one of the high-level specifications is generated by applying a set of transformation rules to one of the low-level specifications.

### BRIEF DESCRIPTION OF THE DRAWINGS

FIG. 1 is an example of a process for verifying software in accordance with some embodiments.

FIGS. 2A, 2B, 3, 4, 8, 9, and 11-13 are code examples illustrating the example process of FIG. 1 in accordance with some embodiments.

FIGS. 5 and 6 show examples of rewrite rules that can be used to reconstruct programs in accordance with some embodiments.

FIG. 7 shows examples of transformation rules that can be used in accordance with some embodiments.

FIG. 10 shows examples of rewrites that can be used to reconstruct a program structure in accordance with some embodiments.

FIG. 14 shows an example of hardware that can be used in accordance with some embodiments.

### DETAILED DESCRIPTION

In some embodiments, mechanisms, including systems, methods, and media, for verifying software are provided. In some of these embodiments, the mechanisms automatically translate unmodified source code, such as C systems code (e.g., that might found in a Linux kernel), into a verification representation (e.g., such as a Coq representation) that it can be automatically verified, and then cause the translation to be executed by a proof assistant to verify the source code.

In some embodiments, these mechanisms leverage a layering proof strategy (e.g., based on Concurrent Certified Abstraction Layers (CCALs)) to modularize and decompose verification into smaller steps to make each verification step easier. In some embodiments, this involves defining a layer structure of the implementation, where each layer includes a group of functions that define the layer's interface. Higher layers in this structure can call the functions exposed by a lower layer's interface, but not the other way around, in some embodiments. In some embodiments, the top layer in the structure is a high-level specification of the behavior of the entire implementation, while the bottom layer in the structure is a machine model whose interface is designed to support language-independent intermediate representation (LIIR) semantics.

In some embodiments, verification involves proving that the layers compositionally refine the top layer specification of the entire implementation.

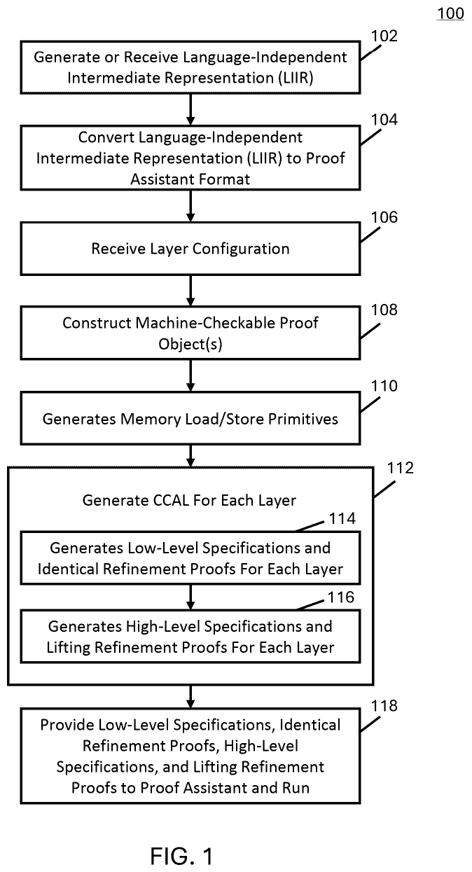

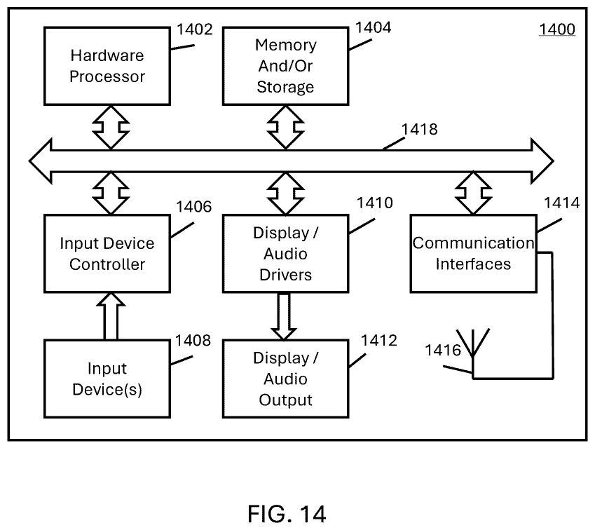

FIG. 1 shows an example 100 of a process for verifying software in accordance with some embodiments. This process can be executed on any suitable hardware, in some embodiments. For example, in some embodiments, this process can be executed by a hardware process as shown and described in connection with FIG. 14 below.

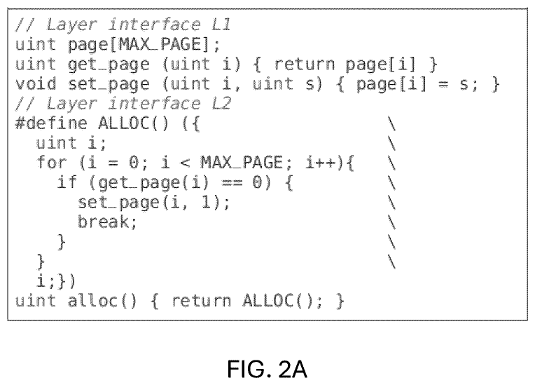

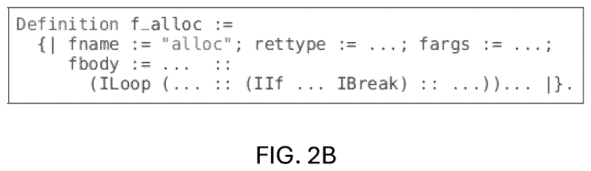

An example shown in FIG. 2A is used hereinafter to help explain and illustrate process 100, in accordance with some embodiments. This example contains a simplified C coding language function called “alloc” that can be used to allocate a free page by scanning an array of page descriptors called “page”. In this example, the main computation is implemented as a statement expression in a macro definition called “ALLOC”, in which a loop is used to iterate all elements of “page” and set the page status of the first free page to “1”. The accesses to “page” are encapsulated into functions called “get_page” and “set_page”. This coding style is quite common in systems software such as Linux kernel code. While a specific example is provided, it should be understood that not all embodiments will operate in the same manner in connection with such an example, and that other examples in the same and/or other languages could be used, in some embodiments.

In accordance with some embodiments, at 102, process 100 generates or receives a language-independent intermediate representation (LIIR) of source code (e.g., such as C system source code).

Any suitable LIIR (e.g., such as LLVM's language-independent intermediate representation (see, llvm.org, which is hereby incorporated by reference herein in its entirety, on the World Wide Web) can be generated or received at 102 and the LIIR can be based on any suitable source code (e.g., such as C system source code), in some embodiments. For example, using LLVM's language-independent intermediate representation as an LIIR for C system source code can enable the LIIR to support full C semantics and various extensions, including arbitrary type casting, integer-pointer conversion, inline assembly code, C macros that use GNU C extensions, and GNU C compiler directives, in some embodiments. As another example, in some embodiments, LLVM's LIIR may be preferred to be used because it is language-independent and machine-independent, supports full C language semantics and most extensions of C, can be easily integrated with assembly code semantics, and is much simpler and more rigorously defined than C.

The LIIR can be generated or received in any suitable manner, in some embodiments. For example, in some embodiments, the LIIR can be generated using a Clang compiler front end to parse C code into a LLVM LIIR, in some embodiments.

Next, at 104, process 100 can convert the LIIR to a proof assistant format. Any suitable proof assistant format can be used for processing by any suitable proof assistant, in some embodiments. For example, in some embodiments, the proof assistant format can be an abstract syntax tree (AST) representation to be used with the Coq proof assistant (which is available on the World Wide Web from coq.inria.fr, the contents of which are hereby incorporated by reference herein in their entireties). This conversion can be performed in any suitable manner in any suitable manner, in some embodiments.

In some embodiments, LIIR code includes structs, global variables, and functions. In some embodiments, process 100, translates LIIR structs (which may be similar to C structs, in some embodiments) and global variables into their Coq representations, and/or performs program reconstruction for LIIR functions. In some embodiments, an LIIR function can be viewed as a control flow graph (CFG) over a set of basic blocks with an entry point. All instructions in such a basic block are sequentially executed, and the last instruction either jumps to another block or returns from the function, in some embodiments.

In some embodiments, LIIR (e.g., LLVM's LIIR) does not keep program structures, such as if-then-else and loop statements, making it hard to conduct proofs in a structural and inductive manner. Thus, in some embodiments, mechanisms described herein can resolve this issue by analyzing control flow graphs of LIIR code and reconstructing program structures as described below. For example, in some embodiments, process 100 can reconstruct the loop, branch, and break statements in Coq representations for the LLVM LIR generated from the alloc function of FIG. 2A as shown in FIG. 2B.

As part of analyzing control flow graphs of LIIR code and reconstructing program structures, in some embodiments, process 100 can merge each function's CFG of basic blocks into one code block and reconstruct program structure using if-then-else, loop, continue, break, and return statements. In some embodiments, any goto statements in the original source code will be eliminated from the proof assistant format. In some embodiments, process 100 reconstructs program structure by repeatedly applying a set of rewrite rules, as described below, to reduce the size of the CFG by merging blocks and deleting edges. In some embodiments, the reconstruction is performed in the LIIR.

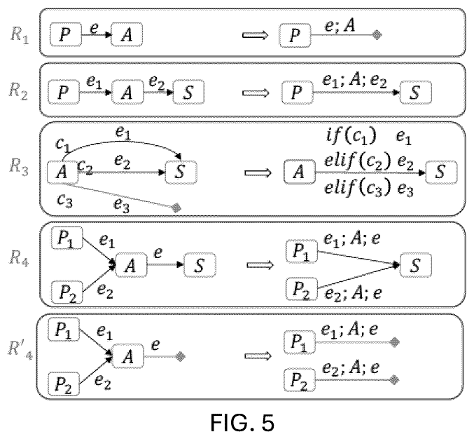

For programs without loops, process 100 can use four rewrite rules to reconstruct programs from CFGs as shown in FIG. 5, in some embodiments. In FIG. 5, each node denotes a code block and each edge denotes a change in control flow. A, P, and S in the nodes denote the instructions inside the respective blocks. c₁, c₂, and c₃ at the beginning of edges denote the conditions to jump through the respective edges. Unlike regular CFGs, e, e₁, and e₂ denote instructions attached to edges which will be executed when jumping through the respective edges. An edge ending with a rhombus denotes an edge without a destination, whose attached instructions must end with a continue statement, a break statement, or a return statement.

The CFG of a function without loops has no cycles, so process 100 can repeatedly apply the rewrite rules to reduce the graph to a single node, in some embodiments.

In some embodiments, rule R₁ deletes a dangling node (i.e., a node with only one incoming edge e and no outgoing edge) and moves its instructions A to its incoming edge, which becomes an edge without a destination and has instructions “e;A.”

In some embodiments, rule R₂ deletes a bridge node A (i.e., a node with exactly one incoming edge e₁ and one outgoing edge e₂) and redirects the incoming edge from its predecessor node P to its successor node S with instructions “e₁;A; e₂.”

In some embodiments, if all the outgoing edges of a node A either point to the same node S or do not have destinations, rule R₃ merges all the edges into one edge with branch statements. Since only the last instruction in a node changes the control flow, when a node has more than one outgoing edge, each edge must have a condition c, in some embodiments.

In some embodiments, if a node has multiple incoming edges but only one outgoing edge, rule R₄ deletes the node and redirects all incoming edges to its successor node S with aggregated instructions. Rule R′₄ (which is logically the same as R₄) is illustrated to show the case when the only outgoing edge does not have a destination.

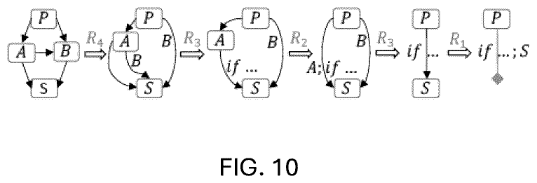

In some embodiments, the reconstruction algorithm prioritizes applying the first three rules and only applies R₄ to the farthest valid node from the entry point if no other rules are applicable. In some embodiments, this algorithm can rewrite any CFGs without loops into a single code block. The example in FIG. 10 shows a sequence of rewrites to reconstruct a program structure from its CFG, in accordance with some embodiments.

Loops introduce cycles into CFGs. For CFGs with cycles, process 100 can compute strongly connected components (SCCs), in some embodiments. In some embodiments, an SCC is the largest set of nodes in which every node is reachable from every other node. One node with self-pointed edges can also be an SCC, in some embodiments.

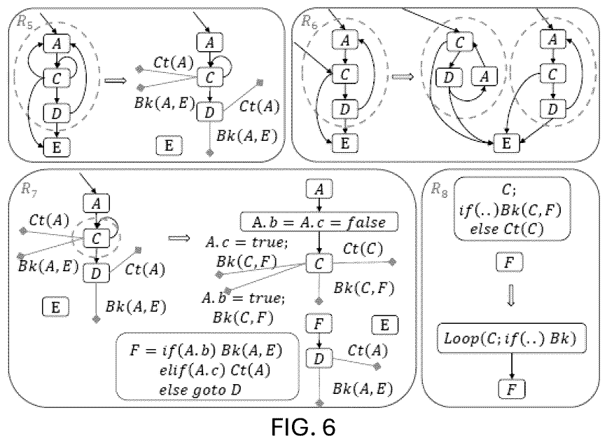

In some embodiments, process 100 use four additional rewrite rules shown in FIG. 6 to convert SCCs (marked by dashed circles) into loop-related statements.

In some embodiments, Rule R₅ breaks cycles in an SCC which only has one incoming edge (pointing to node A in the SCC), and all its outgoing edges point to the same destination (node E outside SCC). It redirects any edge to A in the SCC to having no destination, and appends Ct(A) (a continue statement for the loop A) to the edge. It also redirects any edge to E in the SCC to having no destination, and appends Bk(A,E) (a break statement from the loop A to E) to the edge. After the rewrite, there is no longer a cycle back to node A and the size of the SCC becomes smaller.

In some embodiments, when an SCC has incoming edges from more than one node, rule R₆ duplicates the SCC for each node with incoming edges so that each SCC has only one incoming edge.

In some embodiments, for nested loops in which the inner loop may directly jump out of the outer one, rule R₇ converts such an SCC into one in which the jump target remains within the outer loop. Rule R₇ inserts a new node F, and all outgoing edges from the inner loop are redirected via break statements to F. Flags are also appended to the outgoing edges. Node F contains instructions to jump to different destinations depending on the flag. Flag A.b means breaking the outer loop A, A.c means going back to the beginning of the outer loop A, and no flag means breaking the inner loop.

In some embodiments, once cycles are removed, rule R₈ converts a node's instructions into a single Loop statement, and re-establishes the edge from the loop node to its successor indicated by the break statement.

In some embodiments, process 100 can also handle assembly code by representing assembly instructions as parameterized inductive types in the proof assistant format. Each instruction corresponds to one construct with the operand as the parameter, in some embodiments. Since assembly is not a structured language, in some embodiments, process 100 simply translate each assembly procedure or inline assembly statement into a list of assembly instructions in the proof assistant format.

In some embodiments, for inline assembly code, the LIIR (e.g., when implemented as LLVM's LIIR) already encapsulates it as a function. In some embodiments, process 100 extract such inline assembly code into a separate assembly procedure, and replace the original function body with a call to the assembly procedure, decoupling the inline assembly code from the LIIR in the proof assistant format.

In some embodiments, the semantics of LIIR and assembly instructions in the proof assistant format need to be defined to specify the behavior of the proof assistant format. In some embodiments, semantics are defined with respect to a layer interface for a bottom layer machine model. The interface contains a machine state st and getter and setter methods that access objects in the machine state through object pointers, in some embodiments. In some embodiments, an object pointer is a pair (base, ofs), where base specifies the object and ofs specifies the field or offset within the object. In other words, the semantics of LIIR and assembly instructions define how those instructions use the getter and setter methods and how they update the underlying machine state, in some embodiments. The machine state contains memory blocks and registers, as discussed below, in some embodiments.

In some embodiments, LIIR semantics only depend on memory objects, each of which is a set of disjoint memory blocks that can be accessed using load_mem and store_mem methods through object pointers with boundary checks. In some embodiments, a memory block is contiguous and its size is defined by the type of the respective structure or global variable. For example, in some embodiments, the page array in FIG. 2A is a memory block with (MAX_PAGE×4) bytes and can be accessed using an object pointer (“page”, i), where 0≤i≤MAX_PAGE×4. The layer interface contains a variable environment providing a one-to-one mapping of variable names to corresponding addresses in memory, in some embodiments.

In some embodiments, for assembly code, process 100 model the semantics of the assembly code instructions based on not only memory block objects, but also register objects. For example, in some embodiments, the register objects model that clear the VM bit in the HCR_EL2 register will disable the stage-2 translation for EL1 and EL0. Since an assembly procedure is just a list of assembly instructions, the semantics of an assembly procedure is defined as applying the semantics for each assembly instruction in the list one after the other, in some embodiments.

Based on Concurrent Certified Abstraction Layers (CCALs), process 100 can use CPU-local reasoning and distinguish memory objects as CPU-private memory, lock-synchronized memory, and lock-free memory, in some embodiments. In some embodiments, each CPU-private memory object belongs to and can only be accessed by a particular CPU. Each lock-synchronized memory object is associated with a lock, in some embodiments. When accessing a lock-synchronized memory object, process 100 can check that the corresponding lock is held by the local CPU, in some embodiments. In some embodiments, accessing a lock-free memory object generates an event appended to a global log, and an event oracle is queried to simulate other CPUs' behavior before generating each event. In some embodiments, this event-based machine model assumes sequential consistency (SC).

As shown in FIG. 1, at 106, process 100 receives as input a layer configuration which it uses to scale constructing mechanized proofs using CCALs. The layer configuration can be received in any suitable manner and in any suitable format, in some embodiments. For example, in some embodiments, the layer configuration can be received as a layer configuration file.

Using CCALs, at 108, process 100 can construct one or more machine-checkable proof objects. In some embodiments, a machine-checkable proof object “M@L⊆RL′” shows that an implementation M, built on top of a lower layer interface L, refines the interface L′ with the refinement relation R.

In some embodiments, the layer configuration received at 106 defines the layers and at which layer each function should be verified. For example, in some embodiments, the layer configuration for the running example in FIG. 2A defines that get_page and set_page should be verified on top of layer L0, while alloc should be verified on top of layer L1.

In some embodiments, the layer structure presumes a bottom layer machine model, which process 100 automatically generates in part by identifying each global memory object in the source code and generating a corresponding machine state in the proof assistant format (e.g., Coq).

In some embodiments, at 110, process 100 also generates memory load/store primitives for each element in the state. In some embodiments, the primitives take a memory pointer as an argument and calculate based on an offset the array indices and structure elements to be accessed. In some embodiments, the primitives also perform index boundary and data range checks.

In some embodiments, the initial generated machine model does not include concurrency-related structures, such as an event log or oracle. In some embodiments, these can be manually added to complete the model to support CPU-local concurrency reasoning.

Given the layer configuration, process 100 will automate generating the CCALs at 112.

In the example of FIG. 2A, in some embodiments, process 100 builds a CCAL “M_{page}@L₀⊆_{R_1}L₁” to abstract the page array into a Coq Map object from natural numbers to integers, such that its elements can only be accessed through getter and setter methods, get_page and set_page, respectively, rather than arbitrary memory operations which may lead to unexpected behavior. The refinement relation R₁ (discussed above) defines how the page array is abstracted into the Map object, in some embodiments.

Continuing with the example of FIG. 2A, in some embodiments, it will then build a CCAL “M_{alloc}@L₁⊆_{id}L₂” to verify the alloc function on top of L₁ using the Map object without the need to worry about concrete implementation details of page. Here, “id” is an identical refinement relation since no data abstraction is needed when verifying alloc.

In some embodiments, to make building CCALs easier, process 100 decomposes the required proofs into an identical refinement and a lifting refinement. The identical refinement refines M to a low-level specification S_{low} that is closer to the code and does not introduce any data abstraction, i.e., “M@L⊆_{id}S_{low}”, in some embodiments. The lifting refinement refines the low-level specification to a high-level specification L′, i.e., “S_{low}⊆_{R}L′”, in some embodiments. The high-level specification is self-contained and may introduce abstractions to some data in lower layers, in some embodiments.

In some embodiments, at 114, process 100 generates low-level specifications and identical refinement proofs for each layer.

The low-level specification of a function aggregates the small-step transition of each instruction in the function into a big-step transition of the entire function while preserving the semantics, in some embodiments.

For assembly code and source code (e.g., C code) without loops, in some embodiments, process 100 recursively aggregates small-step semantics of every LIIR statement in a function and generates a proof-assistant-format definition to reflect the entire transition as the low-level specification of the function.

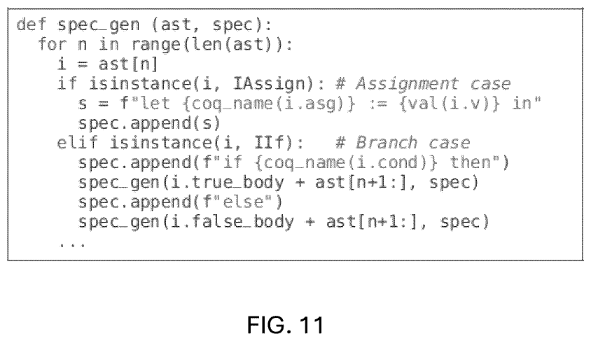

Leveraging the reconstructed program structure, process 100 scans through the proof-assistant-format representation (e.g., Coq AST), conducts case analysis starting with the first statement, and generates a corresponding proof assistant format definition (e.g., a Coq definition) as a string based on the defined LIIR (e.g., LLVM LIIR) semantics. A small piece of Python pseudocode for assignment and branch statements is shown in FIG. 11, as an example, in accordance with some embodiments.

For example, for an IAssign statement which assigns a value to a temporary variable, process 100 generates a let binding in a proof assistant format (e.g., Coq), in some embodiments.

As another example, for an IIf statement, process 100 recursively invokes its specification generator spec_gen for each branch in the code and concatenates the branch body with the rest of the proof assistant format representation (e.g., AST), in some embodiments.

In some embodiments, process 100 provides a proof-assistant-format tactic library to generate the identical refinement proofs for assembly code and source code (e.g., C code) without loops. A tactic is a pre-defined decision procedure to generate proof scripts in the proof assistant format (e.g., Coq), in some embodiments. In some embodiments, neither the specification generator nor tactic library needs to be trusted, since incorrect low-level specifications will be rejected by refinement proofs, and incorrect proofs will be rejected by the proof assistant proof checker.

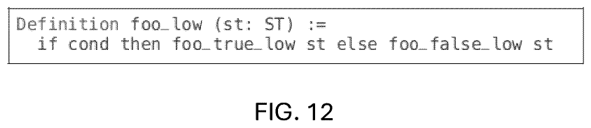

In some embodiments, process 100 automatically generates identical refinement proofs by using a tactic lrefine, in some embodiments. In some embodiments, process 100 performs case analysis for each conditional by recursively decomposing each conditional into two sub-proofs, one for when the conditional is true and another for when it is false. Once a branch body is reached with no further conditionals, in some embodiments, the proof can simply show that if the low-level specification transforms the machine state from state st to state st′, then the small-step semantics of the proof-assistant-format representation (e.g., Coq AST) also transform the machine state from st to st′. Process 100 aggregates the sub-proofs for all the branch cases to form the overall refinement proof, in some embodiments. FIG. 12 shows a pseudo-specification generated from an if statement as an example, in some embodiments.

In some embodiments, the lrefine tactic conducts case analysis over cond, which generates two sub-proof goals. In some embodiments, the first goal is to prove that the proof-assistant-format representation (e.g., AST) transfers state st to state “foo true_low st” with an additional hypothesis “H0: cond=true.” In some embodiments, the lrefine tactic then executes the semantics of the proof-assistant-format representation (e.g., AST) for one step by showing that the branch condition will be evaluated to true when H0 holds. In some embodiments, the lrefine tactic invokes lrefine recursively to prove that the first branch implementation will transfer state st to state “foo_true_low st,” a specification generated using the first branch. The second goal can be proved similarly.

For source code (e.g., C code) with loops, in some embodiments, process 100 can receive for each loop a user-supplied ranking function, which is non-negative and monotonically decreasing during the loop iterations.

With the input ranking function, in some embodiments, process 100 can automatically synthesize a recursive function as the low-level specification using the Fixpoint construction in the proof assistant (e.g., Coq), which requires an argument that decreases for each recursive call.

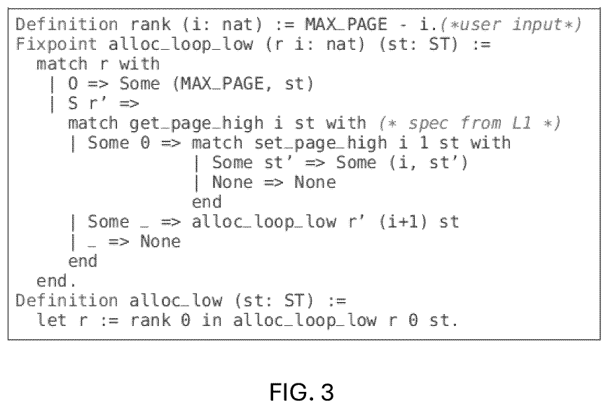

For example, in accordance with some embodiments, FIG. 3 shows a recursive function alloc_loop_low synthesized for the loop in the alloc function with a user-provided ranking function (MAX_PAGE−i) as the decreasing argument for the Fixpoint construction. Note that, in this example, the low-level specification of alloc is not self-contained and depends on functions get_page_high and set_page_high provided by the high-level specification at a lower layer.

In some embodiments, process 100 then generates low-level specifications for loops by filling in certain parts within a uniform induction-proof template.

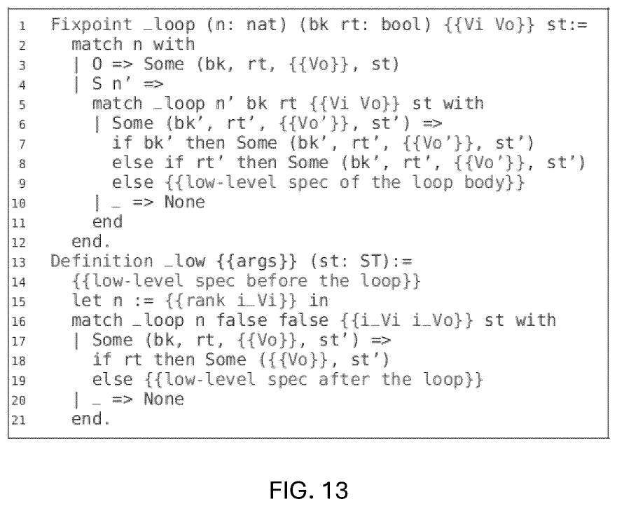

For example, in some embodiments, as shown in FIG. 13, a template can have parts marked with {{ }} that are to be filled in. For the loop in this example, process 100 generates a Fixpoint construction such that one recursive call of the Fixpoint construction corresponds to one iteration of the loop, so its body is the low-level specification of the loop body (line 9 of FIG. 13). Five Fixpoint arguments track the state of the loop (line 1 of FIG. 13). Vi are the input variables initialized before the loop and accessed by the loop body; they have initial values i_Vi. Vo are the output variables accessed after the loop that were also accessed in the loop body; they have initial values i_Vo. As another example, the loop in alloc in FIG. 2A simply has i for both Vi and Vo, with initial values 0 and MAX_PAGE, respectively. In some embodiments, process 100 determines input and output variables and their initial values from syntactic analysis of the LIIR code. In the example of FIG. 13, n is the decreasing argument, which is a natural number that is determined by the user-provided ranking function, which takes as input all the input variables of the loop. n is initialized using the ranking function over the initial value of input variables i_Vi, which sets the maximum number of “loop iterations” (line 15 of FIG. 13), and decreases by one for each “loop iteration” (line 4 of FIG. 13). Flags bk and rt indicate whether the loop has already been terminated by a break or return statement. The loop body (line 9 of FIG. 13) sets bk to true when executing a break statement or exiting when the loop condition becomes false, and sets rt to true when executing a return statement. Fixpoint will not make further changes once bk or rt is set to true (lines 7 and 8 of FIG. 13).

Continuing with the example above, for the function containing the loop in FIG. 13, process 100 generates low-level specifications for the code before the loop (line 14 of FIG. 13); invokes the Fixpoint with the initial values of the ranking function, flags, and variables (line 16 of FIG. 13); skips the rest of the function if rt is true (line 18 of FIG. 13); and generates low-level specifications for the code after the loop if not returned (line 19 of FIG. 13). Process 100 syntactically analyzes the IR code and produces Vi, Vo, and their initial values i_Vi and i_Vo. Note that FIG. 3 shows a simplified low-level specification that omits the bk and rt flags and uses a tail recursion style.

In some embodiments, process 100 proves identical refinements for loops using induction. The base case is trivial because the input machine states are the same.

In some embodiments, process 100 only needs to prove that the initial ranking function is non-negative. This is automated using a tactic xlia, extended from Coq's tactic lia, a decision procedure for arithmetic, in some embodiments.

In some embodiments, the induction step is to show that when the input machine states for the low-level specification and proof-assistant-format representation (e.g., Coq AST) are the same after the i-th iteration and both bk and rt are false, the output machine states are still the same after the (i+1)-st iteration. The (i+1)-st iteration may have one of three outcomes:
i. continue to the next iteration;
ii. break the loop due to a break statement or the loop condition becoming false); and
iii. return from the function.

In some embodiments, for all three outcomes, process 100 first proves that the loop body and Fixpoint body have the same semantics by recursively invoking lrefine and then proves additional properties for each outcome.

For the first outcome, process 100 proves that the ranking function decreases by at least one and is still greater than zero using xlia, in some embodiments. This guarantees that the loop must terminate after at most the number of iterations indicated by the initial ranking function, in some embodiments.

For the second outcome, process 100 proves that bk is true after the iteration, and the ranking function is still non-negative when the loop condition becomes false using xlia, in some embodiments.

For the third outcome, process 100 proves that rt is true after the iteration, in some embodiments. Note that the Fixpoint function continues the iteration after bk or rt is true but will not make any changes to the state, in some embodiments.

In some embodiments, process 100 automatically generates the identical refinement proof for a loop if the loop is not contained within a conditional in the function.

In some embodiments, process 100 generates low-level specifications for assembly code by evaluating the assembly instruction list. In doing so, process 100 evaluates instructions sequentially and outputs the machine state of the last instruction, in some embodiments.

In some embodiments, if the destination of a call instruction is a C function, process 100 uses registers according to the Procedure Call Standard for the Arm 64-bit Architecture (AAPCS64), which is hereby incorporated by reference herein in its entirety. Process 100 sets the arguments to the values in the argument registers according to AAPCS64, in some embodiments. After the function call, process 100 checks the linker register of the machine state and evaluates the assembly instruction from where the linker register points, in some embodiments. After returning from the function call to assembly code, process 100 sets the value of the caller-saved registers to UNKNOWN because the caller cannot assume any value in the caller-saved registers according to AAPCS64, in some embodiments. In some embodiments, process 100 disallows reads from any register with value UNKNOWN; assembly code must write to the caller-saved register first before it can be read. This helps prevent unexpected information leakage from registers, in some embodiments.

In some embodiments, by using the AAPCS64 calling conventions for assembly code functions so that arguments and return values are treated the same as C code functions, process 100 provides a unified approach to generating low-level specifications for assembly and C code. This includes using the same type value used in the LIIR semantics for assembly code, in some embodiments. This unified approach makes it possible to link the proofs for assembly and C code, in some embodiments.

In some embodiments, process 100 generates low-level specifications for inline assembly in the same manner as other assembly code, since it already extracts the inline assembly into a separate assembly code procedure. Process 100 requires that the operands used in inline assembly are C variables specified in the input or output operand list, system registers, and constants, in some embodiments. Directly reading or writing general-purpose registers is disallowed to ensure proof correctness when linking inline assembly and C code, as the compiler may use them for temporary variables, in some embodiments.

In some embodiments, process 100 automatically generates identical refinement proofs for assembly code, which is straightforward without jumps as there are also no loops. The proof simply shows that the low-level specification and assembly instruction list transform the machine state in the same way, in some embodiments.

In some embodiments, process 100 generates high-level specifications and lifting refinement proofs for each layer at 116 of FIG. 1. This is done automatically when data abstractions are not used to hide low-level data representation details to simplify proofs at higher layers, in some embodiments. If data abstractions are needed, users need to formulate the refinement relations, define abstract operations, and conduct the refinement proofs manually, in some embodiments.

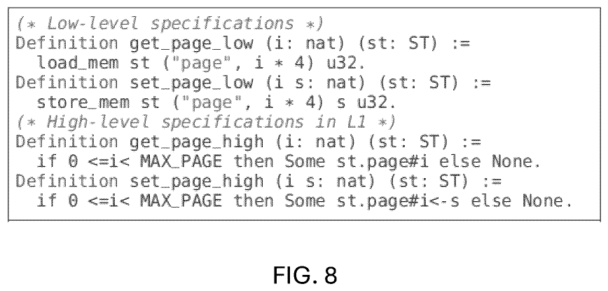

For example, in some embodiments, as shown in FIG. 8, the layer L1 abstracts the array page into a Coq Map st.page, and transforms the memory operations load_mem and store_mem—offered by the bottom layer L0's machine model—into Map operations (st.page #i and st.page #i<−s) with boundary checks.

In some embodiments, because of the data abstraction, the lifting refinement proof for layer L1 is not automated and has to be provided manually.

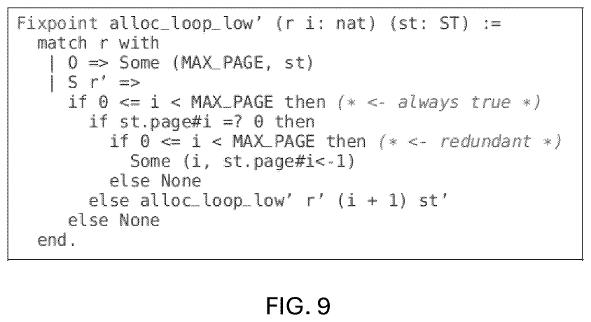

On the other hand, the layer L2 does not use data abstractions, in some embodiments. For layer L2, process 100 automatically generates the high-level specification of alloc from its low-level specification by applying a sequence of transformation rules, including unfolding definitions, merging near-duplicate sub-expressions, eliminating pre-determined branches and assertions, and performing mathematical simplification. The latter two rules can be applied by using the Z3 Theorem Prover available from Microsoft Corporation of Redmond, Washington, in some embodiments. For alloc_loop_low in FIG. 3, process 100 first unfolds the definitions provided by L₁ and simplifies the representation as shown in FIG. 9, in some embodiments.

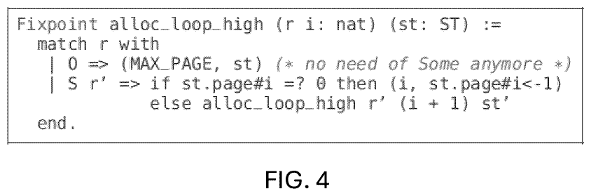

In some embodiments, process 100 then applies rules to eliminate an inner if statement which is redundant and eliminate the outer if statement by inferring that i is always within the range, resulting in the high-level specification in L2 shown in FIG. 4. Unlike the low-level specification, the high-level specification in L2 is self-contained and does not refer to anything from L1. Thus, any modules depending on L2 can be reasoned about using L2 alone without the need to look at lower layers, in some embodiments.

In some embodiments, process 100 automatically generates refinement proofs to verify the transformations that are applied to transform low-level into high-level specifications. In some embodiments, since all specifications are guarded by machine-checkable proofs in the proof assistant (e.g., Coq), there is no need to trust process 100's specification generation algorithms or any Z3 results.

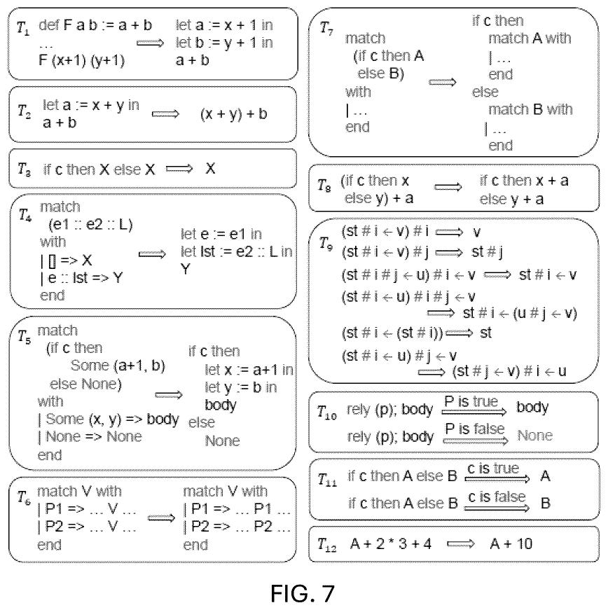

In some embodiments, process 100 generates high-level specifications by applying a set of transformation rules (described below) to low-level specifications to make them self-contained and simple. In some embodiments, process 100 uses 12 transformation rules shown in FIG. 7, though additional or alternative rules can be added in some embodiments. Process 100 uses the Z3 Theorem Prover (which may be referred to herein as Z3) to apply rules involving symbolic execution or mathematical simplification, in some embodiments. The goal of the transformation rules is to simplify the required control flow and eliminate as many unnecessary operations as possible, in some embodiments.

In some embodiments, T₁ unfolds a function's definition in an expression. Functions defined in lower layers that are called in the low-level specification are generally unfolded as part of the high-level specification to make it self-contained, in some embodiments. Unfolding may also provide opportunities to apply other transformation rules to eliminate unnecessary operations to further simplify the specification, in some embodiments.

T₂ eliminates a let assignment by substituting the variable with its value, which helps find opportunities for simplifying expressions, in some embodiments.

In some embodiments, T₃ eliminates an if branch if both branches are the same.

T₄ eliminates a match statement by syntactically determining which pattern matches the source value, in some embodiments.

In some embodiments, T₅ eliminates a match statement if both the source and return values are of Option type, and if the source value is None, the return value is None. T₅ eliminates the match by making body the return value for all source values that are not None, in some embodiments.

T₆ transforms a match statement in which the source value matches the pattern and is used in the return value by substituting the pattern in the return value, in some embodiments. This can provide more opportunities for simplification since patterns are more specific, in some embodiments.

In some embodiments, T₇ moves the control flow of the source value to the outside of the match statement. Process 100 tries to simplify the source value of match statements to make it easier to determine matching patterns, in some embodiments.

T₈ moves the control flow within an expression to the outside of the expression to aggregate computations within the expression, which helps find opportunities for simplifying expressions, in some embodiments.

In some embodiments, T₉ does various simplifications for getter and setter methods. Here i and j indicate different fields. Whether i equals j can be determined syntactically (if they are structure names), or by Z3 (if they are integer indices), in some embodiments.

T₁₀ performs symbolic execution using Z3 to identify whether the assertion of a rely is valid or invalid, in some embodiments. If the assertion is always true, then rely is redundant and can be removed, in some embodiments. If the assertion is always false, the statement can simply return None, in some embodiments. T10 will do nothing if Z3 cannot decide if the assertion is true or false, in some embodiments.

In some embodiments, T₁₁ performs symbolic execution using Z3 to simplify if statements.

T₁₂ simplifies math expressions using Z3, in some embodiments. For example, process 100 applies T₁, T₂, and T₁₁ to generate the high-level specification in FIG. 4 from its low-level specification, in some embodiments.

While the transformation rules can be applied in different orders to yield the same result, the order in which the rules are applied can have a significant impact on the execution time required, in some embodiments. In some embodiments, process 100 reduces execution time by applying the rules in stages. For example, in the first stage, process 100 applies rules T₂-T₈ and the T₉ syntactic transformations, in some embodiments. As another example, in the second stage, process 100 applies rule T₁, then repeats applying the rules from the first stage, in some embodiments. In some embodiments, process 100 unfolds only one function, and only when no other syntactic rules can apply, because unfolding multiple functions too early can cause extra work. As yet another example, in the third stage, process 100 applies rules that use Z3, specifically rules T₉-T₁₂, then repeats applying the rules from the first and second stages, in some embodiments.

In some embodiments, process 100 applies syntactic rules first to simplify the specification as much as possible before applying Z3 rules because Z3 rules take much longer to process. To avoid long Z3 processing times, process 100 enforces a short timeout on Z3 operations, which can be set to half a second (or any other suitable value) by default, in some embodiments. In some embodiments, process 100 repeatedly applies all rules until the high-level specification converges, meaning the rules no longer change the specification, in some embodiments.

Using transformation rules to make the high-level specification of each layer self-contained generally results in the high-level specification being of larger size than its corresponding low-level specification, in some embodiments. However, this size increase is outweighed by the ability to use the self-contained specification to simplify reasoning for higher layers, especially with regard to reasoning about higher-level properties based on the top layer high-level specification, in some embodiments.

In some embodiments, process 100 automatically generates lifting refinement proofs to prove that the low-level specification refines the high-level specification generated by the transformation rules. In some embodiments, this will necessarily be the case for transformation rules done in Coq, so the task reduces to reconstructing the proofs in Coq for all transformations done by Z3; there is no need to trust any results from Z3. In some embodiments, process 100 uses a Coq tactic library to enable the proof automation.

In some embodiments, process 100 simplifies the construction of refinement proofs by introducing annotated high-level specifications, which are the same as high-level specifications except that they have additional annotations that encapsulate the results of all of the Z3 transformations applied. For example, in some embodiments, if T₁₁ is applied, there will be an annotation showing that A+2*3+4=A+10, which serves as a hint for constructing proofs. In some embodiments, process 100 generates the annotations as it is generating the high-level specification.

Process 100 then uses the annotations to tell the proof assistant (e.g., Coq) what step-by-step syntactic substitutions it should perform to prove the low-level specification refines the annotated high-level specification, in some embodiments. In some embodiments, because the annotations tell process 100 what transformations to perform, it only has to validate them in the proof assistant (e.g., Coq), which is much easier than automatically discovering the transformations in the proof assistant (e.g., Coq); that would be difficult without Z3. In some embodiments, process 100 finally trivially proves that the annotated high-level specification refines the high-level specification by showing that removing the annotations does not change the machine behavior. The two-part refinement proof shows that the low-level specification refines the high-level specification.

In some embodiments, process 100 introduces a Coq tactic hrefine to automate the core part of the proof, namely proving that the low-level specification is equivalent to the annotated high-level specification. The strategy of hrefine is similar to the one for lrefine used for the identical refinement proof discussed above, in some embodiments. The hrefine tactic analyzes the structure of the annotated high-level specification, decomposes it into all possible branches of state transitions, and conducts the proof for each branch, in some embodiments. For each branch, all match, if, and rely are eliminated because the branch corresponds to a specific set of values for their conditions, in some embodiments. Each branch therefore has a list of conditions and annotations, in some embodiments. In some embodiments, process 100 uses those conditions and annotations to simplify the low-level specification and prove that the low-level specification has the same behavior as the high-level one for that branch. It then repeats this process to prove the refinement for each branch.

Finally, at 118, process 100 provides the low-level specifications, the identical refinement proofs, the high-level specifications, and the lifting refinement proofs to the proof assistant and cause the proof assistant to use them to verify the code. The low-level specifications, the identical refinement proofs, the high-level specifications, and the lifting refinement proofs can be provided to the proof assistant in any suitable manner, and the proof assistant can be caused to use them to verify the code in any suitable manner, in some embodiments. In response, process 100 can receive a response from the proof assistant indicating whether the code has been verified or not, and then take any suitable action in response thereto, such as preventing the code from being executed.

The mechanisms, including process 100, described herein can be implemented in any suitable computing device. For example, in some embodiments, the mechanisms described herein can be implemented using any suitable general-purpose computer or special-purpose computer(s). Any such general-purpose computer or special-purpose computer can include any suitable hardware. For example, as illustrated in example hardware 1400 of FIG. 14, such hardware can include hardware processor 1402, memory and/or storage 1404, an input device controller 1406, an input device 1408, display/audio drivers 1410, display and audio output circuitry 1412, communication interface(s) 1414, an antenna 1416, and a bus 1418.

Hardware processor 1402 can include any suitable hardware processor, such as a graphical processing unit (GPU), a microprocessor, a micro-controller, digital signal processor(s), dedicated logic, and/or any other suitable circuitry for controlling the functioning of a general-purpose computer or a special purpose computer in some embodiments.

Memory and/or storage 1404 can be any suitable memory and/or storage for storing programs, data, and/or any other suitable information in some embodiments. For example, memory and/or storage 1404 can include random access memory, read-only memory, flash memory, hard disk storage, optical media, and/or any other suitable memory.

Input device controller 1406 can be any suitable circuitry for controlling and receiving input from input device(s) 1408 (such as a keyboard, mouse, touchscreen, etc.), in some embodiments.

Display/audio drivers 1410 can be any suitable circuitry for controlling and driving output to one or more display/audio output circuitries 1412 in some embodiments. For example, display/audio drivers 1410 can be circuitry for driving one or more display/audio output circuitries 1412, such as an LCD display, a speaker, an LED, or any other type of output device.

Communication interface(s) 1414 can be any suitable circuitry for interfacing with one or more communication networks. For example, interface(s) 1414 can include network interface card circuitry, wireless communication circuitry, and/or any other suitable type of communication network circuitry.

Antenna 1416 can be any suitable one or more antennas for wirelessly communicating with a communication network in some embodiments. In some embodiments, antenna 1416 can be omitted when not needed.

Bus 1418 can be any suitable mechanism for communicating between two or more components 1402, 1404, 1406, 1410, and 1414 in some embodiments.

Any other suitable components can additionally or alternatively be included in hardware 1400 in accordance with some embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for verifying software, comprising:
memory; and
at least one hardware processor collectively configured to at least:
identify a plurality of layers of code of the software including a lowest layer, a middle layer, and a highest layer;
generate a low-level specification and an identical refinement proof for each of the plurality of layers;
generate a high-level specification and a lifting refinement proof for each of the plurality of layers; and
verify the software based on the low-level specifications, the identical refinement proofs, the high-level specifications, and the lifting refinement proofs.

2. The system of claim 1, wherein one of the low-level specifications is generated using Fixedpoint construction.

3. The system of claim 1, wherein one of the high-level specifications is generated by applying a set of transformation rules to one of the low-level specifications.

4. A method for verifying software, comprising:
identifying a plurality of layers of code of the software including a lowest layer, a middle layer, and a highest layer;
generating a low-level specification and an identical refinement proof for each of the plurality of layers using a hardware processor;
generating a high-level specification and a lifting refinement proof for each of the plurality of layers; and
verifying the software based on the low-level specifications, the identical refinement proofs, the high-level specifications, and the lifting refinement proofs.

5. The method of claim 1, wherein one of the low-level specifications is generated using Fixedpoint construction.

6. The method of claim 1, wherein one of the high-level specifications is generated by applying a set of transformation rules to one of the low-level specifications.

7. A non-transitory computer-readable medium containing computer executable instructions that, when executed by a processor, cause the processor to perform a method for verifying software, the method comprising:
identifying a plurality of layers of code of the software including a lowest layer, a middle layer, and a highest layer;
generating a low-level specification and an identical refinement proof for each of the plurality of layers;
generating a high-level specification and a lifting refinement proof for each of the plurality of layers; and
verifying the software based on the low-level specifications, the identical refinement proofs, the high-level specifications, and the lifting refinement proofs.

8. The non-transitory computer-readable medium of claim 1, wherein one of the low-level specifications is generated using Fixedpoint construction.

9. The non-transitory computer-readable medium of claim 1, wherein one of the high-level specifications is generated by applying a set of transformation rules to one of the low-level specifications.
